(19) United States
(12) Patent Application Publication
(10) Pub. No.: US 2013/0021407 A1
(43) Pub. Date: Jan. 24, 2013

(54) NOZZLE SURFACE CLEANING DEVICE AND LIQUID DROPLET EJECTING APPARATUS

(71) Applicant: Noriaki MAIDA, Kanagawa (JP)

(72) Inventor: Noriaki MAIDA, Kanagawa (JP)

(21) Appl. No.: 13/551,292

(22) Filed: Jul. 17, 2012

(30) Foreign Application Priority Data
Jul. 21, 2011 (JP) P2011-160136

(51) Int. Cl. B41J 2/165

(52) U.S. Cl. 347/28

(57) ABSTRACT

A nozzle surface cleaning device includes an ink jet head having a nozzle surface with a nozzle disposed therein, a cleaning solution supplying unit that faces the nozzle surface and supplies a cleaning solution, a movement unit that moves one of the cleaning solution supplying unit and the head in longitudinal and traverse directions of the head, and a movement amount control unit that controls a movement amount of at least one of the cleaning solution supplying unit and the head. The movement amount control unit adjusts an amount of the cleaning solution adhering to the nozzle surface by moving them in the traverse direction by using the movement unit in accordance with an uncleanness state of the nozzle surface or an operation history of the head to relatively change a position at which the nozzle surface and the cleaning solution supplying unit face and overlap with each other.

### BACKGROUND OF THE INVENTION

1. Field of the Invention

The present invention relates to a nozzle surface cleaning device and a liquid droplet ejecting apparatus, and, more particularly, to a nozzle surface cleaning device and a liquid droplet ejecting apparatus that can change an adhering amount of a cleaning solution in accordance with the conditions of the uncleanness or the operation of an ejection head.

2. Description of the Related Art

Various foreign materials such as ink residue and paper powder adhere to the nozzle surface and the nozzle edge of an ink jet head, which is used in an ink jet recording apparatus, due to use. When foreign material adheres to the nozzle surface, ink liquid droplets ejected from the nozzle are affected, the ejection direction of ink liquid droplets becomes uneven, and it becomes difficult to apply ink liquid droplets at predetermined positions on a recording medium, which causes image quality degradation. Thus, in order to avoid an ejection abnormality caused by material adhering to the nozzle surface, the nozzle surface is configured to be appropriately cleaned.

For example, in JP2007-7977A, a liquid droplet ejecting apparatus is disclosed, which includes supply selecting means for selecting supply or non-supply of a cleaning solution based on predetermined conditions. In addition, in JP4389499B, an ink jet recording head cleaning device is disclosed, which includes ultrasonic oscillating means for exciting a cleaning solution by oscillating an ultrasonic wave having a frequency equal to or higher than 700 kHz and cleaning solution jetting means for jetting the cleaning solution in a direction opposite to the ejection direction of ink ejected from the nozzle by pressurizing the cleaning solution.

### SUMMARY OF THE INVENTION

However, the liquid droplet ejecting apparatus disclosed in JP2007-7977A implements a method for selecting supply or non-supply of the cleaning solution to the ejection head, and accordingly, only switching between dry-state wiping and wet-state wiping can be performed. It is difficult for two types of wiping methods to respond to a more detailed operation history of the ejection head, and an optimal wiping state could not be considered to have been realized. In addition, although the cleaning device disclosed in JP4389499B is configured so as to directly spray the cleaning solution to the vicinity of the nozzle, switching between maintenance conditions based on the operation history of the ejection head is not considered therein.

The present invention is contrived in view of such situations, and an object thereof is to provide a nozzle surface cleaning device and a liquid droplet ejecting apparatus that can perform maintenance under optimal conditions by performing the wet state when wiping using a cleaning solution in accordance with a plurality of conditions.

In order to achieve the above-described object, according to an aspect of the present invention, there is provide a nozzle surface cleaning device including: an ink jet head having a nozzle surface in which a nozzle for ejecting a liquid is disposed; a cleaning solution supplying unit that faces the nozzle surface and supplies a cleaning solution; a movement unit that moves at least one of the cleaning solution supplying unit and the ink jet head in a longitudinal direction and a traverse direction of the ink jet head; and a movement amount control unit that controls the movement amount moving by the movement unit of at least one of the cleaning solution supplying unit and the ink jet head, wherein the movement amount control unit adjusts an amount of the cleaning solution adhering to the nozzle surface by moving at least one of the cleaning solution supplying unit and the ink jet head in the traverse direction of the ink jet head by using the movement unit in accordance with one of an uncleanness state of the nozzle surface and an operation history of the ink jet head so as to relatively change a position at which the nozzle surface and the cleaning solution supplying unit face and overlap with each other.

According to this embodiment, by moving at least one of the cleaning solution supplying unit and the ink jet head in the traverse direction of the ink jet head, the cleaning solution is supplied from the cleaning solution supplying unit, and the area of the nozzle surface to which the clearing solution adheres can be decreased, whereby the amount of the cleaning solution adhering to the nozzle surface can be adjusted. Accordingly, since the amount of the cleaning solution that is used for cleaning the nozzle surface can be changed in accordance with the state of the uncleanness of the nozzle surface and the operation history, the maintenance conditions can be changed without changing the wiping conditions, whereby the cleaning performance can be improved.

In the nozzle surface cleaning device according to this aspect, it is preferable that the cleaning solution supplying unit include: a cleaning solution maintaining face that is separated from the nozzle surface by a predetermined distance and is disposed in parallel with the nozzle surface; and a cleaning solution supplying port that supplies the cleaning solution to the cleaning solution maintaining face.

According to the nozzle surface cleaning device of this aspect, the cleaning solution supplying unit includes the cleaning solution supplying port that supplies the cleaning solution to the cleaning solution maintaining face disposed in parallel with the nozzle surface, and, by supplying the cleaning solution to the cleaning solution maintaining face, the cleaning solution can be made to adhere to the nozzle surface.

In the nozzle surface cleaning device according to this aspect, it is preferable that the cleaning solution supplying unit fill between the nozzle surface and the cleaning solution maintaining face with the cleaning solution.

According to the nozzle surface cleaning device of this aspect, a film of the cleaning solution can be formed between the nozzle surface and the cleaning solution maintaining face, and thereby the film of the cleaning solution and the nozzle surface are brought into contact with each other. Accordingly, the cleaning solution uniformly adheres to the nozzle face.

In the nozzle surface cleaning device according to this aspect, it is preferable that the nozzle surface be inclined with respect to a horizontal plane.

According to the nozzle surface cleaning device of this aspect, by disposing the nozzle surface to be inclined with respect to the horizontal plane, the cleaning solution supplying unit is also disposed to be inclined. Accordingly, by supplying the cleaning solution from the upper portion of the cleaning solution maintaining face of the cleaning solution supplying unit, the film of the cleaning solution can be easily formed on the cleaning solution maintaining face by using the inclination of the cleaning solution maintaining face.

In the nozzle surface cleaning device according to this aspect, it is preferable that a supporting member that is adjacent to the nozzle surface and supports the nozzle surface be further included, and the movement amount control unit adjust the adhering amount of the cleaning solution to the supporting member.

According to the nozzle surface cleaning device of this aspect, the supporting member that is adjacent to the nozzle surface and supports the nozzle surface is disposed, and, by adjusting the amount of the cleaning solution adhering to the supporting member, the amount of the cleaning solution adhering to the nozzle surface is adjusted. Thus, the cleaning solution can be made to reliably adhere to the nozzle surface.

In the nozzle surface cleaning device according to this aspect, it is preferable that the cleaning solution supplying port be disposed on a cleaning solution maintaining face side that faces the nozzle surface.

According to the nozzle surface cleaning device of this aspect, since the cleaning solution is supplied from the cleaning solution supplying port disposed on the side facing the nozzle surface, a film of the cleaning solution can be easily formed and thereby the cleaning solution can be made to uniformly adhere to the nozzle surface.

In the nozzle surface cleaning device according to this aspect, it is preferable that the adhering amount of the cleaning solution be increased by adjusting the movement amount as an unused time of the nozzle increases.

According to the nozzle surface cleaning device of this aspect, since the adhering amount of the cleaning solution is changed in accordance with the unused time after use of the nozzle, the maintenance can be performed in consideration of the state of the nozzle surface until the next use after the maintenance.

Since the state of ink drawn from the nozzle surface or the time required for stabilizing the printing quality varies in accordance with the moisture state of a web, it is preferable that the adhering amount of the cleaning solution be increased or decreased in accordance with the nozzle state. For example, it is preferable to perform the maintenance with the low-moisture web in cases such as where printing is sequentially restarted during printing, because the printing quality is stable in such the low-moisture maintenance although a wipe mark remains on the nozzle surface. On the other hand, in the maintenance with a high-moisture web, although the nozzle surface can be maintained to be extremely clean, it takes time to stabilize the printing quality. Accordingly, it is preferable to perform the high-moisture maintenance in a case where the unused time is long, such as at closing time or the like.

As above, by changing the maintenance conditions by adjusting the adhering amount of the cleaning solution in accordance with the length of the standby time after use, maintenance can be performed under optimal conditions.

In the nozzle surface cleaning device according to this aspect, it is preferable that the adhering amount of the cleaning solution be changed by adjusting the movement amount in accordance with the printing pattern of a formed image.

According to the nozzle surface cleaning device of this aspect, by adjusting the moisture of the web in accordance with the formed printing pattern, a nozzle that is in a severely unclean state due to use can be selectively cleaned.

In the nozzle surface cleaning device according to this aspect, it is preferable that the adhering amount of the cleaning solution be increased by adjusting the movement amount as the number of prints increase.

According to the nozzle surface cleaning device of this aspect, it is assumed that, as the number of prints increases, the nozzle is used for the printing thereof, and dirt adherers thereto. Accordingly, the adhering amount of the cleaning solution can be increased as the number of prints increases, whereby cleaning can be efficiently performed at optimal conditions in accordance with the degree of uncleanness of the nozzle surface.

In order to achieve the above-described object, according to another aspect of the present invention, there is provided a liquid droplet ejecting apparatus including the above-described nozzle surface cleaning device.

By using the above-described nozzle cleaning device, liquid droplets can be ejected in a constantly clean state in which the nozzle surface is cleaned, and accordingly, the liquid droplet ejecting apparatus can be appropriately used.

According to a nozzle surface cleaning device and a liquid droplet ejecting apparatus of the present invention, the amount of the cleaning solution adhering to a nozzle surface is adjusted in accordance with the state of the uncleanness of the nozzle surface or the operation history. Accordingly, maintenance can be performed in a plurality of different moisture conditions when performing maintenance. Accordingly, the nozzle surface can be cleaned effectively and efficiently, and the cleaning quality can be improved. In addition, the maintenance can be performed at different conditions by changing the adhering amount of the cleaning solution without changing the wiping conditions after the application of the cleaning solution.

### BRIEF DESCRIPTION OF THE DRAWINGS

FIG. 1 is a diagram that illustrates the whole configuration of an ink jet recording apparatus in which a nozzle surface cleaning device according to this embodiment is used.

FIG. 2 is a plan view that illustrates an example of the configuration of an ink jet head illustrated in FIG. 1.

FIG. 3 is a partially enlarged view of FIG. 2.

FIGS. 4A and 4B are planar perspective views of a head module that is illustrated in FIG. 2.

FIG. 5 is a diagram that illustrates the whole configuration of a maintenance processing unit.

FIG. 6 is a diagram that illustrates the whole configuration of a cleaning processing unit in which the nozzle surface cleaning device according to this embodiment is used.

FIG. 7 is a diagram that illustrates the arrangement relation between the cleaning processing unit illustrated in FIG. 6 and the head.

FIG. 8 is a diagram that illustrates the arrangement relation after the cleaning processing unit is moved in parallel with an ejection face of the head.

FIG. 9 is a graph that illustrates the relation between the cleaning solution adhering amount and the distance between an end portion of the ejection face and a cleaning solution supplying port.

FIG. 10 is a block diagram of the main portions that illustrates the system configuration of the ink jet recording apparatus illustrated in FIG. 1.

### DESCRIPTION OF THE PREFERRED EMBODIMENTS

Hereinafter, preferred embodiments of the present invention will be described with reference to the accompanying drawings.

Whole Configuration of ink Jet Recording Apparatus

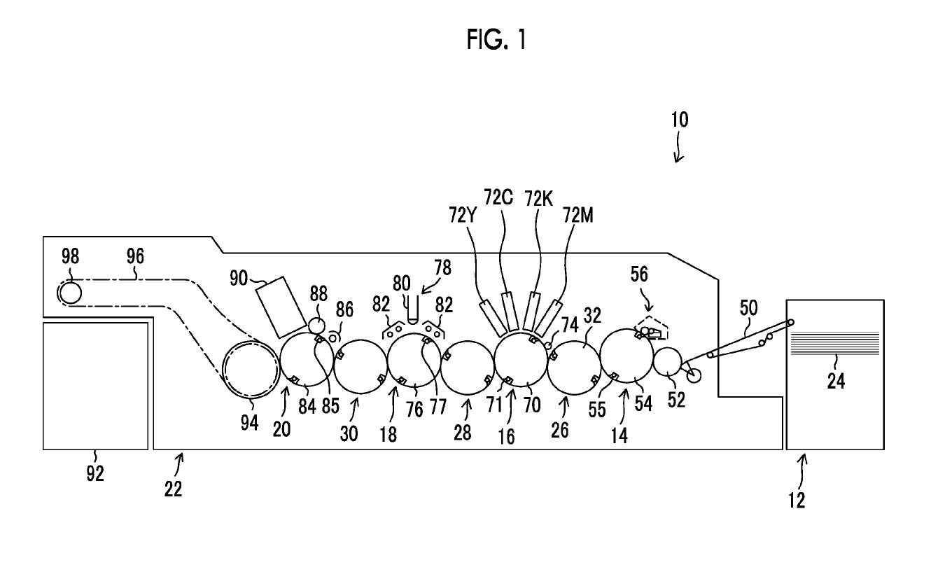

First, the whole configuration of an ink jet recording apparatus according to the present invention will be described. FIG. 1 is a configuration diagram that illustrates the whole configuration of the ink jet recording apparatus.

This ink jet recording apparatus 10 is an ink jet recording apparatus of a cylinder direct drawing-type that forms a desired color image by ejecting ink of a plurality of colors from ink jet heads 72M, 72K, 72C, and 72Y to a recording medium 24 (for the convenience of description, it may be referred to as a “paper sheet”) that is maintained on a cylinder (drawing drum 70) of a drawing unit 16. The ink jet recording apparatus 10 is also an image forming apparatus of an on-demand type to which a two-liquid reaction (here, cohesion) system is applied in which a processing liquid (here, a cohesive processing liquid) is applied on the recording medium 24 before the ejection of ink, and an image is formed on the recording medium 24 by causing the processing liquid and an ink liquid to react with each other.

As illustrated in the figure, the ink jet recording apparatus 10 is mainly configured to include a sheet feeding unit 12, a processing liquid applying unit 14, a drawing unit 16, a drying unit 18, a fixing unit 20, and a discharging unit 22.

Sheet Feeding Unit

The sheet feeding unit 12 is a mechanism that supplies the recording medium 24 to the processing liquid applying unit 14, and recording media 24, which are sheets of paper, are stacked in the sheet feeding unit 12. In the sheet feeding unit 12, a sheet feeding tray 50 is disposed, and the recording media 24 are fed from the sheet feeding tray 50 to the processing liquid applying unit 14 one sheet at a time.

In the ink jet recording apparatus 10 of this example, as the recording media 24, a plurality of types of recording media 24 of which the types of paper or the sizes (sheet sizes) are different from each other can be used. In the sheet feeding unit 12, a plurality of sheet feeding trays (not shown) is included which accumulate various types of recording media in a separated manner, and an aspect of automatically switching among the plurality of sheet trays from which a sheet is transmitted to the sheet feeding tray 50 may be included. In addition, an aspect may be included in which an operator selects a sheet tray or performs switching between sheet trays as is necessary. In addition, in this example, although a sheet of paper (cut sheet) is used as the recording medium 24, a configuration may be employed in which a necessary size is cut out from continuous paper (roll paper) so as to be fed.

Processing Liquid Applying Unit

The processing liquid applying unit 14 is a mechanism that applies a processing liquid to a recording face of the recording medium 24. The processing liquid contains a coloring material coagulant, which is applied by the drawing unit 16, causing a coloring material (in this example, a pigment) contained in the ink to cohere, and, by allowing the processing liquid and ink to be brought into contact with each other, the coloring material is precipitated to be separated from a solvent in the ink.

As illustrated in FIG. 1, the processing liquid applying unit 14 includes a sheet feeding cylinder 52, a processing liquid drum 54, and a processing liquid coating device 56. The processing liquid drum 54 is a drum that rotates and conveys the recording medium 24 while holding it. The processing liquid drum 54 includes claw-shaped holding means (gripper) 55 on the outer circumferential face thereof, and, by interposing the recording medium 24 between the claw of the holding means 55 and the circumferential face of the processing liquid drum 54, the front end of the recording medium 24 can be held. It may be configured such that a suction hole is formed on the outer circumferential face of the processing liquid drum 54, and suction means for performing suction from the suction hole is connected thereto. Through this, the recording medium 24 can be held on the circumferential face of the processing liquid drum 54 so as to be brought into contact therewith in a tight manner.

On the outer side of the processing liquid drum 54, the processing liquid coating device 56 is disposed so as to face the circumferential face of the processing liquid drum 54. The processing liquid coating device 56 is configured by a processing liquid container in which the processing liquid is stored, an anilox roller that is partially dipped into the processing liquid of the processing liquid container, and a rubber roller that is brought into contact with the anilox roller and the recording medium 24 disposed on the processing liquid drum 54 in a pressing manner and transfers the processing liquid after measurement to the recording medium 24. According to this processing liquid coating device 56, the recording medium 24 can be coated with the processing liquid while the processing liquid is measured.

The recording medium 24 to which the processing liquid has been applied by the processing liquid applying unit 14 is delivered to the drawing drum 70 of the drawing unit 16 from the processing liquid drum 54 through an intermediate conveying unit 26.

Drawing Unit

The drawing unit 16 includes the drawing drum (second conveying body) 70, a sheet suppressing roller 74, and ink jet heads 72M, 72K, 72C, and 72Y The drawing drum 70, similarly to the processing liquid drum 54, includes claw-shaped holding means (gripper) 71 on the outer circumferential face thereof. The recording medium 24 that is fixed to the drawing drum 70 is conveyed such that the recording face faces the outer side, and ink is applied to the recording face from the ink jet heads 72M, 72K, 72C, and 72Y.

It is preferable that the ink jet heads 72M, 72K, 72C, and 72Y be formed as ink jet-type recording heads (ink jet head) of a full-line type having a length corresponding to the maximum width of the image forming area of the recording medium 24. In an ink ejecting face, a nozzle row is formed in which a plurality of nozzles used for ejecting ink is arranged over the entire width of the image forming area. Each one of the ink jet heads 72M, 72K, 72C, and 72Y are disposed so as to extend in a direction perpendicular to the conveying direction (the rotation direction of the drawing drum 70) of the recording medium 24.

By ejecting corresponding liquid droplets of color ink from the ink jet heads 72M, 72K, 72C, and 72Y toward the recording face of the recording medium 24 that is held on the drawing drum 70 in a tightly contact manner, the ink is brought into contact with the processing liquid that has been applied in advance by the processing liquid applying unit 14, and accordingly, the coloring material (pigment) that disperses in the ink coheres so as to form a coloring material coagulant. Accordingly, the flow of the coloring material and the like on the recording medium 24 is prevented, whereby an image is formed on the recording face of the recording medium 24.

In this example, although the configuration of standard colors (four colors) CMYK is illustrated as an example, the combination of ink colors or the number of colors is not limited to that of this embodiment, and light ink, dark ink, or special-color ink may be added as is necessary. For example, configuration may be employed in which ink jet heads ejecting ink of light-system colors such as light cyan, light magenta, and the like are added, and arrangement order of the color heads is not particularly limited.

The recording medium 24 on which an image is formed by the drawing unit 16 is delivered from the drawing drum 70 to the drying drum 76 of the drying unit 18 through an intermediate conveying unit 28.

Drying Unit

The drying unit 18 is a mechanism that dries the moisture contained in the solvent that is separated by the coloring material cohesion reaction and, as illustrated in FIG. 1, includes a drying drum 76 and a solvent drying device 78.

The drying drum 76, similarly to the processing liquid drum 54, includes claw-shaped holding means (gripper) 77 on the outer circumferential face thereof, and the front end of the recording medium 24 can be held by the holding means 77.

The solvent drying device 78 is arranged at a position facing the outer circumferential face of the drying drum 76 and is configured by a plurality of IR heaters 82 and hot air jetting nozzles 80 that are arranged between the IR heaters 82.

By appropriately adjusting the temperature and the air volume of warm air that is jetted from each hot air jetting nozzle 80 toward the recording medium 24 and the temperature of each IR heater 82, various drying conditions can be realized.

In addition, the surface temperature of the drying drum 76 is set to be equal to or higher than 50° C. By heating the recording medium 24 from the rear face, the drying is precipitated, whereby image destruction at the time of fixation can be prevented. In addition, although the upper limit of the surface temperature of the drying drum 76 is not particularly limited, from the viewpoint of the stability (prevention of a skin burn due to a high temperature) of a maintenance operation such as cleaning ink adhering to the surface of the drying drum 76, it is preferable that the surface temperature is set to 75° C. or less (more preferably, 60° C. or less).

By holding the recording medium 24 on the outer circumferential face of the drying drum 76 such that the recording face thereof faces the outer side (in other words, in a curved state in which the recording face of the recording medium 24 is the convex side) and drying the recording medium 24 while it is conveyed in a rotating manner, the occurrence of folding or floating of the recording medium can be prevented, whereby uneven drying can be reliably prevented.

The recording medium 24 for which the drying process has been performed by the drying unit 18 is delivered from the drying drum 76 to the fixing drum 84 of the fixing unit 20 through an intermediate conveying unit 30.

Fixing Unit

The fixing unit 20 is configured by a fixing drum 84, a halogen heater 86, a fixing roller 88, and an in-line sensor 90. The fixing drum 84, similarly to the processing liquid drum 54, includes claw-shaped holding means (gripper) 85 on the outer circumferential face thereof, and the front end of the recording medium 24 can be held by the holding means 85.

The recording medium 24 is conveyed such that the recording face faces the outer side in accordance with the rotation of the fixing drum 84, and, for the recording face, preliminary heating using the halogen heater 86, a fixing process using the fixing roller 88, and a test using the in-line sensor 90 are performed.

The halogen heater 86 is controlled to be at a predetermined temperature (for example, 180° C.). Accordingly, a preliminary heating process is performed for the recording medium 24.

The fixing roller 88 is a roller member that is used for forming ink as a film by welding self-dispersing thermoplastic resin microparticles contained in the ink by heating and compressing the dried ink and is configured so as to heat and compress the recording medium 24. More specifically, the fixing roller 88 is arranged so as to be brought into contact with the fixing drum 84 in a pressing manner, and a nip roller is configured between the fixing drum 84 and the fixing roller 88. Accordingly, the recording medium 24 is interposed between the fixing roller 88 and the fixing drum 84 so as to be nipped at predetermined nip pressure (for example, 0.15 MPa), whereby a fixing process is performed.

In addition, the fixing roller 88 is configured by a heating roller that is acquired by building a halogen lamp inside a metal pipe made from aluminum having high thermal conductivity or the like and is controlled to be at a predetermined temperature (for example 60° C. to 80° C.). By heating the recording medium 24 with the heating roller, thermal energy that is equal to or higher than the Tg temperature (glass transition point temperature) of the thermoplastic resin microparticles contained in the ink is given, whereby the thermoplastic resin microparticles melt. Accordingly, push-in fixing is performed against the unevenness of the recording medium 24, and the unevenness of the image surface is leveled so as to acquire glossiness.

In addition, in the embodiment illustrated in FIG. 1, although a configuration is employed in which only one fixing roller 88 is disposed, a configuration may be employed in which a plurality of stages of the fixing rollers 88 is disposed in accordance with the thickness of the image layer and the Tg property of the thermoplastic resin microparticles.

The in-line sensor 90 is measuring means for measuring the check pattern, the amount of moisture, the surface temperature, the degree of glossiness, and the like of the image fixed to the recording medium 24, and a CCD line sensor or the like is used.

According to the fixing unit 20 configured as described above, the thermoplastic resin microparticles included in the image layer of a thin layer that is formed by the drying unit 18 are melted by being heated and compressed by the fixing roller 88, and thus, can be reliably fixed to the recording medium 24. In addition, by setting the surface temperature of the fixing drum 84 to 50° C. or higher, the recording medium 24 held on the outer circumferential face of the fixing drum 84 is heated from the rear face so as to precipitate the drying thereof, and accordingly, the image destruction at the time of fixation can be prevented, and the image intensity can be improved by a temperature rise effect of the image temperature.

In addition, in a case where UV-curable monomers are contained in the ink, by emitting UV rays to the image using the fixing unit that includes a UV emission lamp after the moisture is sufficiently volatilized by the drying unit, the UV-curable monomers are cured and polymerized, whereby the image intensity can be improved.

Discharging Unit

As illustrated in FIG. 1, the discharging unit 22 is disposed so as to follow the fixing unit 20. The discharging unit 22 includes a discharging tray 92, and, between the discharging tray 92 and the fixing drum 84 of the fixing unit 20, a delivery cylinder 94, a conveying belt 96, and a tension roller 98 are disposed so as to face the discharging tray 92 and the fixing unit 20. The recording medium 24 is sent to the conveying belt 96 by the delivery cylinder 94 and is discharged to the discharge tray 92.

In addition, although not shown, the ink jet recording apparatus 10 of this example, in addition to the above-described configuration, includes an ink storing/charging unit that supplies ink to the ink jet heads 72M, 72K, 72C, and 72Y and means for supplying the processing liquid to the processing liquid applying unit 14 and includes a head maintenance unit that cleans (wipes or purges the nozzle surface, or performs nozzle suction, or the like) of each one of the ink jet heads 72M, 72K, 72C, and 72Y, a position detecting sensor that detects the position of the recording medium 24 on the sheet conveying path, a temperature sensor that detects the temperature of each unit of the apparatus, and the like.

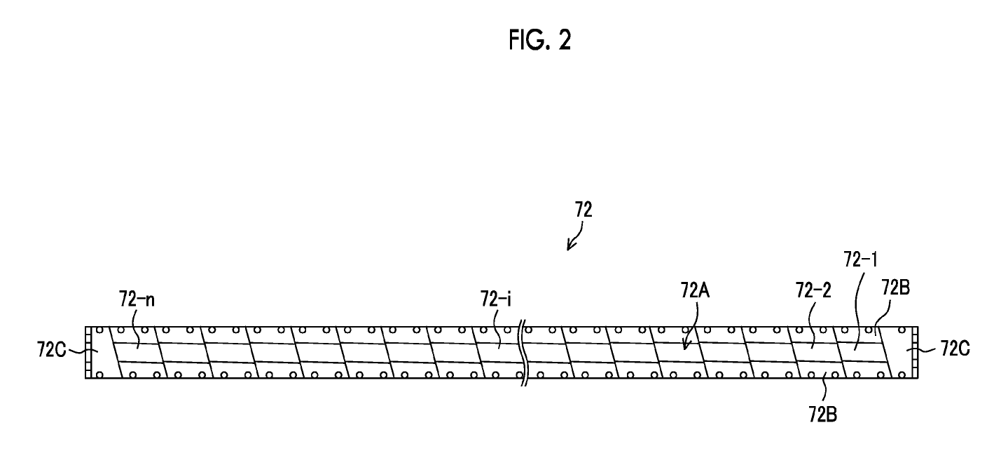

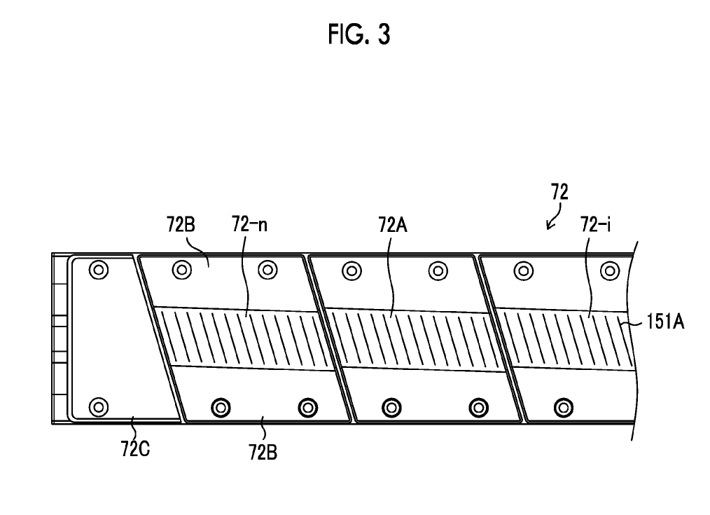

FIG. 2 is a plan view that illustrates an example of the structure of a head 72 and is a diagram of the head 72 viewed from a nozzle surface 72A. In addition, FIG. 3 is a partially enlarged view of FIG. 2.

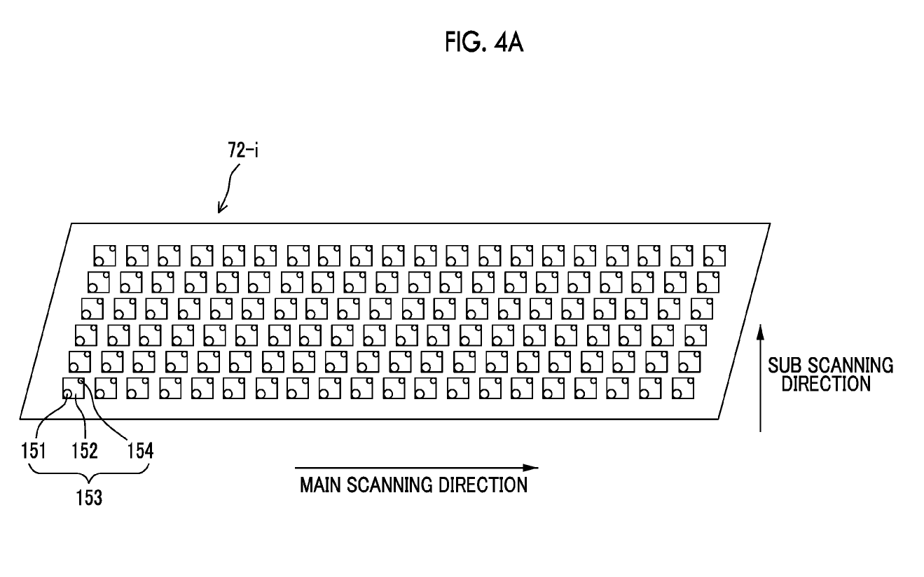

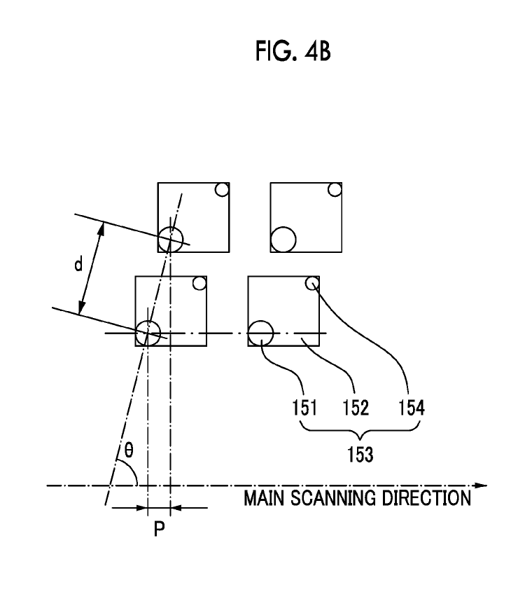

As illustrated in FIGS. 4A and 4B, the head 72 has a structure in which n-number of head modules 72-i (here, i=1, 2, 3, . . . , n) are combined along a longitudinal direction (i.e., a direction perpendicular to the conveying direction of the recording medium 24 (see FIG. 1)). A plurality of nozzles (not illustrated in FIG. 2) is disposed over the length corresponding to the whole width of the recording medium 24.

Each head module 72-i is supported by head module supporting members 72B on both sides of the head 72 in the traverse direction. In addition, both end portions of the head 72 in the longitudinal direction is supported by the head supporting member 72C.

As illustrated in FIG. 3, each head module 72-i (the n-th head module 72-n) has a structure in which a plurality of nozzles is arranged in a matrix pattern. In FIG. 3, solid lines having an inclination denoted by assigning reference numeral 151A thereto represent a nozzle row in which a plurality of nozzles is aligned in one row.

FIG. 4A is a planar perspective view of the head module 72-i, and FIG. 4B is an enlarged view of a part thereof.

In order to increase the density of the pitch of dots that are formed on the recording medium 24, the density of the nozzle pitch of the head 72 needs to be increased. The head module 72-i of this example, as illustrated in FIGS. 4A and 4B, has a structure in which a plurality of ink chamber units (a liquid droplet ejecting element as the unit of a recording element) 153, each formed by a nozzle 151 as an ink ejecting port, a pressure chamber 152 corresponding to each nozzle 151, and the like, is arranged in a matrix pattern (two-dimensionally) when viewed from the top, and, accordingly, high density of the substantial nozzle gap (projected nozzle pitch) that is projected so as to be aligned along the longitudinal direction (a direction perpendicular to the conveying direction of the recording medium 24; a main scanning direction) of the head is achieved.

The pressure chamber 152 that is disposed in correspondence with each nozzle 151 has an approximately square shape as the planar shape thereof, and, in one of both diagonal corner portions, the nozzle 151 is disposed, and a supply port 154 is disposed on the other corner portion. The shape of the pressure chamber 152 is not limited to that of this example, and there may be various forms in which the planar shape is a quadrangle (a rhombus, a rectangle, or the like), a pentagon, a hexagon, or any other polygon, a circle, an oval, or the like.

A plurality of the ink chamber units 153 having such a structure, as illustrated in FIG. 4B, is arranged in a lattice shape in a predetermined arrangement pattern along the row direction along the main scanning direction and a row direction that is not perpendicular to the main scanning direction but has an inclination of a constant angle θ with respect to the main scanning direction, whereby a high-density nozzle head of this example is realized.

In other words, by employing a structure in which a plurality of the ink chamber units 153 is arranged at a constant pitch d along the direction of an angle θ with respect to the main scanning direction, the pitch P of nozzles projected so as to be aligned in the main scanning direction is d x cosθ, and, in the main scanning direction, and the structure can be equally treated as a structure in which the nozzles 151 are arranged in a linear shape at a constant pitch P. By employing such a configuration, a high-density nozzle configuration can be realized in which the nozzle row projected so as to be aligned in the main scanning direction reaches 2400 nozzles per inch.

In addition, in performing the present invention, the arrangement structure of nozzles is not limited to the illustrated example, and various arrangement structures of nozzles including an arrangement structure in which one nozzle row is disposed in the sub-scanning direction may be employed.

Maintenance Unit

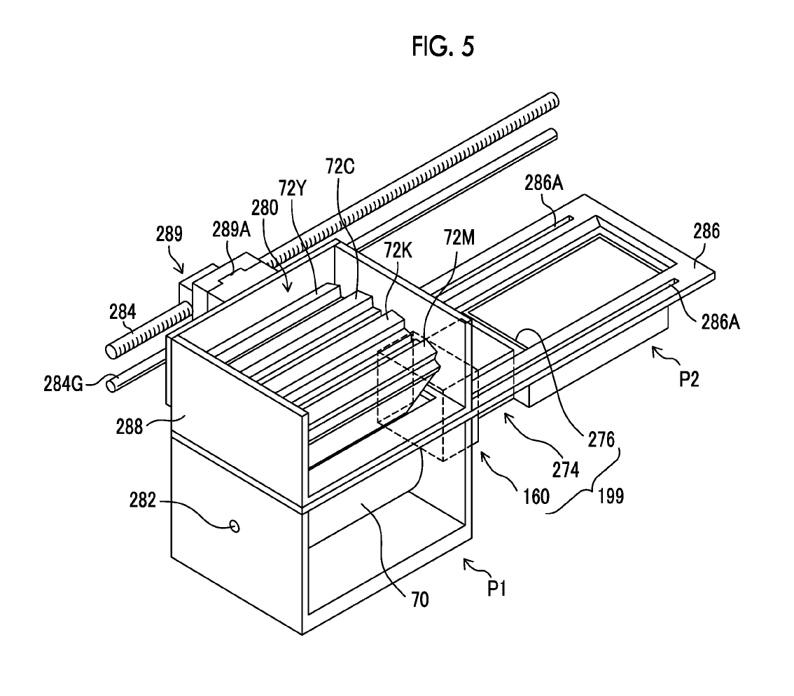

FIG. 5 is a perspective view of a maintenance processing unit 199 that is disposed to be adjacent to the drawing unit 16. As illustrated in the figure, on the outer side of the drawing drum 70, the maintenance processing unit 199 is disposed so as to be adjacent to the drawing unit 16 in the axial direction of the drawing drum 70, which is used for performing a maintenance process for the heads 72M, 72K, 72C, 72Y

In the maintenance processing unit 199, from the drawing drum 70 side, a cleaning processing unit 160, a wiping unit 274, and a nozzle cap 276 are arranged so as to be aligned in this order.

A head unit 280, in which heads 72M, 72K, 72C, and 72Y corresponding to each color are mounted, is installed to a ball screw 284 that is arranged to be parallel to a rotation shaft 282 of the drawing drum 70. On the lower side of the ball screw 284, a guide shaft 284G is arranged in parallel with the ball screw 284, and the head unit 280 is engaged with the guide shaft 284G in a slidable manner. In addition, on the lower side of the head unit 280, a guide rail member 286 that includes a guide groove 286A guiding the movement of the head unit 280 is arranged in parallel with the ball screw 284.

On the lower face of a casing 288 of the head unit 280 that integrally holds the heads 72M, 72K, 72C, and 72Y, an engagement portion (not shown) that is engaged with the guide groove 286A is formed so as to protrude, and the head unit 280 can be guided to the guide groove 286A so as to be movable in accordance with a structure in which the engagement portion is engaged with the guide groove 286A in a slidable manner.

The ball screw 284, the guide shaft 284G and the guide rail member 286, as illustrated in FIG. 5, are disposed to extend along the shaft direction of the drawing drum 70 by a length that is necessary for moving the head unit 280 from an image forming position P1 located at the upper portion of the drawing drum 70 to a position (maintenance position P2) facing the nozzle cap 276.

The ball screw 284 is rotated by driving means (for example, a motor) not shown, and the head unit 280 moves between the image forming position P1 and the maintenance position P2 in accordance with the rotation. In addition, the head unit 280 can be moved in a direction separating away from the drawing drum 70 or in a direction approaching the drawing drum 70 by a vertical moving mechanism that is not shown.

The height (a clearance between the recording face of the recording medium 24 and each one of the heads 72M, 72K, 72C, and 72Y) of the head unit 280 with respect to the surface of the drawing drum 70 is controlled in accordance with the thickness of a used recording medium 24. In addition, in a case where a jam or the like occurs when the sheet is conveyed, by moving the head unit 280 to the upper side in FIG. 5, the head unit 280 can retreat from a position of a predetermined height when forming an image.

In addition, a connection part 289 of the casing 288 of the head unit 280 and the ball screw 284 and the guide shaft 284G, as illustrated in FIG. 4, employs an engagement structure 289A, that can linearly move, guiding the movement of the head unit 280 in the vertical direction.

Cleaning Processing Unit

The cleaning processing unit 160 that is illustrated in FIG. 5 will be described further in detail.

Whole Configuration of Cleaning Processing Unit

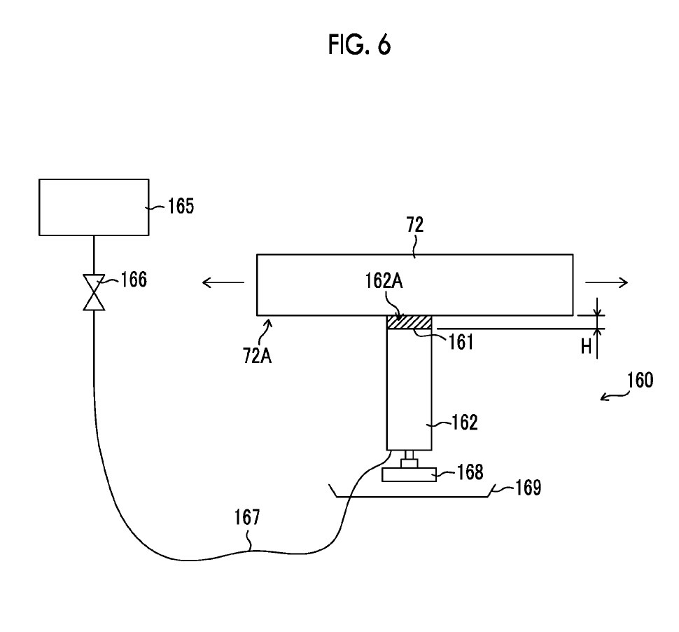

FIG. 6 is a schematic diagram illustrating the configuration of the cleaning processing unit 160. This figure is a diagram of a full line-type head 72 viewed in a width transmission direction (sub-scanning direction), and the direction passing through the sheet face of the figure is the traverse direction (recording medium conveying direction; sub-scanning direction) of the head 72.

The cleaning processing unit 160 includes a cleaning solution coating unit that coats the ejection face with a cleaning solution, or that forms a liquid film of the cleaning solution and thereby coats the ejection face with the cleaning solution in order to adhere the cleaning solution to the ejection face. The cleaning processing unit 160 further includes a cleaning solution tank 165 that stores the cleaning solution supplied to the cleaning solution coating unit 162 and a valve 166 that switches the supply of the cleaning solution. The cleaning processing unit 160 further includes a cleaning solution supplying pipe 167 that supplies the cleaning solution to the cleaning solution coating unit 162 and a collection tray 169 that collects a cleaning solution that has fallen from the head 72 or the cleaning solution coating unit 162. The cleaning processing unit 160 further includes moving means 168 (movement unit) that moves the cleaning solution coating unit 162.

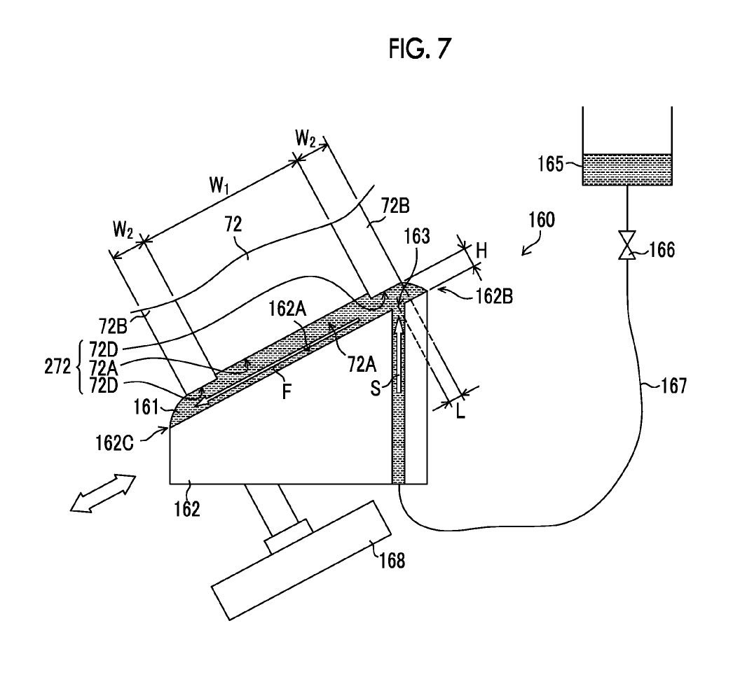

FIG. 7 is a whole configuration diagram that illustrates a schematic configuration of the cleaning solution coating unit 162. The cleaning solution coating unit 162 includes a cleaning solution maintaining face 162A on which the cleaning solution used for coating the ejection face 272 of the head 72 is maintained. In addition, a cleaning solution supplying port 163 used for supplying the cleaning solution to the cleaning solution maintaining face 162A is disposed in an upper portion 162B of the inclination of the cleaning solution maintaining face 162A. Here, the ejection face 272 of the head 72 is a face on which the nozzle surface 72A and wing covers (nozzle surface side) 72D of the head module supporting members 72B arranged on both sides of the nozzle surface 72A in the recording medium conveying direction are combined.

A small amount of the cleaning solution flowing between the ejection face 272 of the head 72 and the cleaning solution maintaining face 162A from the cleaning solution supplying port 163 spreads broadly using the liquid repellency of the ejection face 272 and slips down along the inclined face while forming a meniscus between the ejection face 272 and the cleaning solution maintaining face 162A. In FIG. 7, a white arrow to which reference sign F is assigned represents the movement direction (in the left downward direction in FIG. 7) of a coating layer 161 of the cleaning solution.

The cleaning solution that has slipped down along the cleaning solution maintaining face 162A falls down to the collection tray (not illustrated in FIG. 7 but illustrated in FIG. 6 by assigning reference numeral 169 thereto) that is disposed in a lower portion 162C of the inclination of the cleaning solution maintaining face 162A. When a pump (not shown) is operated, the used cleaning solution is collected in the collecting tray, is sent to the cleaning solution tank 165 through a filter (not shown), and is reused.

In order for the cleaning solution to slip down along the inclination face while forming the meniscus between the ejection face 272 and the cleaning solution maintaining face 162A, it is necessary to appropriately optimize the surface nature (contact angle) of the ejection face, the surface nature (contact angle) of the cleaning solution maintaining face, the physical property (viscosity) of the cleaning solution, the flow rate (the supply amount per unit time) of the cleaning solution, and the shape and the size of the cleaning solution supplying port.

In this example, the contact angle of the nozzle surface is set to 90 degrees, the contact angle of the wing cover is set to 80 degrees, the viscosity of the cleaning solution is set to 2.3 cP, the flow rate of the cleaning solution per unit time is set to 45 mL/min, the shape of the cleaning solution supplying port is set to φ1.7 mm, and a clearance H between the nozzle surface 72A and the cleaning solution maintaining face 162A is set to 1 mm.

Under the above-described conditions, when the cleaning solution is supplied between the ejection face 272 and the cleaning solution maintaining face 162A, the cleaning solution moves between the nozzle surface 72A and the cleaning solution maintaining face 162A while broadly spreading.

By controlling the supply amount of the cleaning solution such that the flow rate of the cleaning solution is equal to or higher than 30 mm/min and is equal to or lower than 60 mm/min, the cleaning solution moves between the ejection face 272 and the cleaning solution maintaining face 162A while broadly spreading, whereby the nozzle surface 72A can be cleaned with a small amount of cleaning solution.

In addition, by setting the clearance H between the ejection face 272 and the cleaning solution maintaining face 162A to be equal to or larger than 0.5 mm and is equal to or smaller than 1.5 mm, the cleaning solution moves between the nozzle surface 72A and the cleaning solution maintaining face 162A while broadly spreading.

As the material of the cleaning solution maintaining face 162A, a metal material (for example, stainless) or a resin material is used. In addition, it is preferable that the cleaning solution maintaining face 162A has such a surface nature that the contact angle of the cleaning solution with respect to the cleaning solution maintaining face 162A is equal to or larger than 60 degrees. Although a case has been described in which the cleaning solution maintaining face 162A is disposed to be parallel with the ejection face 272, “to be parallel” described here includes to be approximately parallel, and, as long as a predetermined clearance can be maintained between the cleaning solution maintaining face 162A and the ejection face 272, the cleaning solution maintaining face 162A may be inclined with respect to the ejection face 272 and may be not only a planar face but also a curved face.

It is preferable that a length from the cleaning solution supplying port 163 to the lower portion 162C of the inclination of the cleaning solution maintaining face 162A exceeds a length (W1+W2×2) acquired by adding the length of the nozzle surface and the lengths W2 of the wing covers 72D disposed on both sides.

As the cleaning solution, a dedicated liquid is used, which has a physical property for dissolving solidified ink adhering to the nozzle surface 72A, has a physical property for forming a coating layer 161 of the cleaning solution on the cleaning solution maintaining face 162A, and has a relatively high cleaning effect. For example, a cleaning solution in which a solvent such as DEGmBE (DiEthylene Glycol MonoButyl Ether) is contained may be used.

In FIG. 7, although at least one cleaning solution supplying port 163 may be disposed in the longitudinal direction of the head 72, a form may be employed in which a plurality of cleaning solution supplying ports 163 is included in the longitudinal direction of the head 72.

As the planar shape of the opening portion of the cleaning solution supplying port 163, a circular shape having a diameter of 1.7 mm is used. In addition, as the planar shape of the cleaning solution supplying port 163, a shape other than the circle shape such as an oval, a quadrangle, or a polygon may be used. Furthermore, the size of the cleaning solution supplying port 163 can be appropriately determined in accordance with the physical property of the cleaning solution and the like. Accordingly, it may be configured such that a plurality of cleaning solution supplying ports 163 having mutually different shapes is disposed in the cleaning solution coating unit 162. In such a case, an appropriate cleaning solution supplying port 163 that can cause a desired amount of the cleaning solution to adhere to the ejection face is selected from the plurality of cleaning solution supplying ports 163 and used.

In addition, in this embodiment, although a method has been described in which coating using the cleaning solution is performed by the nozzle as the cleaning solution supplying port, the cleaning solution may be caused to adhere from a face facing the ejection face 272 by using a spray instead of the nozzle.

The cleaning solution supplying port 163 communicates with an internal flow path, which is not shown, formed inside the cleaning solution coating unit 162. The flow path is connected to the cleaning solution tank 165 through a cleaning solution inlet (not shown) disposed in the lower face of the cleaning solution coating unit 162, the cleaning solution supplying pipe 167 for communicating with the cleaning solution inlet, and the valve 166. By disposing the cleaning solution tank 165 at a position higher than that of the cleaning solution coating unit 162, the cleaning solution can be supplied based on a head pressure difference, whereby switching between supply or no supply of the cleaning solution can be performed by the valve 166. By opening the valve, a predetermined amount of cleaning solution is supplied from the cleaning solution tank 165 to the cleaning solution supplying port 163. A white arrow illustrated in FIG. 7 by assigning reference sign S illustrates the movement direction of the cleaning solution inside the cleaning solution coating unit 162. In addition, by disposing a float sensor inside the cleaning solution tank 165, the cleaning solution inside the cleaning solution tank 165 can be maintained at a constant level.

By moving the cleaning solution coating unit 162 having such a structure in the longitudinal direction of the head 72 (i.e., the direction passing through the sheet face of FIG. 7) in a state where the coating layer 161 of the cleaning solution is maintained between the nozzle surface 72A and the cleaning solution maintaining face 162A, the ejection face 272 of the head 72 is coated with the cleaning solution.

The movement speed of the head 72, for example, can be set to 40 (mm/sec), and, by causing the cleaning solution to uniformly adhere over the whole face of the ejection face 272, the flow rate of the cleaning solution between the ejection face 272 and the cleaning solution maintaining face 162A can be configured to be the same as that described above.

The cleaning solution coating unit 162 includes the moving means 168 that moves the cleaning solution maintaining face 162A in parallel along the ejection face 272 in a direction perpendicular to the direction in which the head 72 moves between the maintenance position P2 and the image forming position P1.

The moving means 168 moves the cleaning solution coating unit 162 in parallel along the inclining direction of the ejection face 272 of the head 72. The ejection face 272 of the head 72, as described above, is configured by the nozzle surface 72A and the wing covers 72D formed by the head module supporting members 72B disposed on both ends in the widthwise direction of the head.

According to this embodiment, the amount of cleaning solution adhering to the ejection face 272 is adjusted by moving the cleaning solution coating unit 162 using the moving means 168. By adjusting the amount of cleaning solution adhering thereto, the moisture when performing wiping using a wiping member after the cleaning solution coating can be adjusted.

The adjustment of the adhering amount of the cleaning solution can be performed by adjusting the overlapping of the ejection face 272 and the cleaning solution maintaining face 162A. In other words, the adhering amount of the cleaning solution is the largest in a state in which the whole face of the ejection face 272 and the whole face of the cleaning solution maintaining face 162A overlap with each other. By moving the cleaning solution coating unit 162, the overlapping of the ejection face 272 and the cleaning solution maintaining face 162A is controlled, and thereby the amount of the cleaning solution adhering to the wing covers 72D is controlled. Accordingly, the adhering amount of the cleaning solution on the whole face of the ejection face 272 is adjusted.

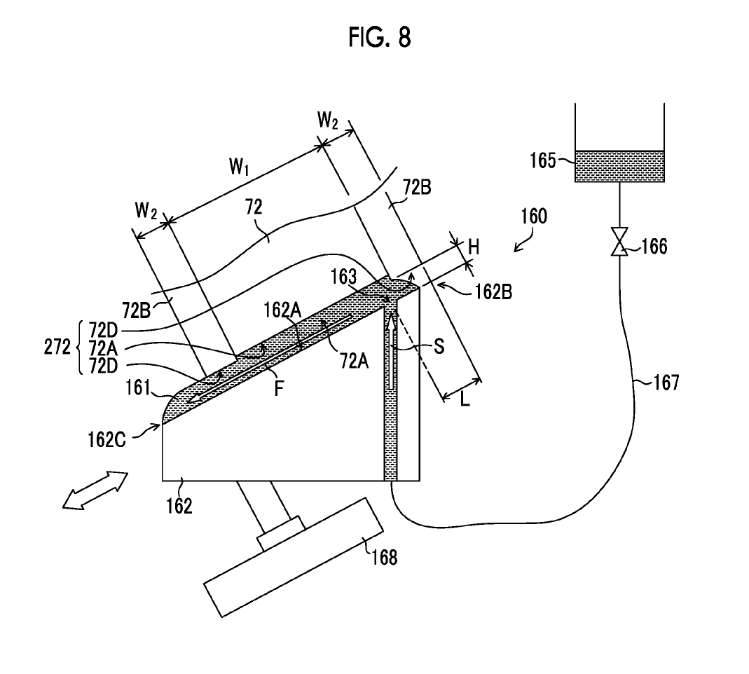

FIG. 8 is a diagram that illustrates a state in which the moving means 168 moves the cleaning solution coating unit 162 to the lower side in the inclining direction, and the coating layer 161 of the cleaning solution is not brought into contact with the wing covers 72D disposed on the upper side in the inclining direction of the head 72.

As illustrated in FIG. 8, the movement of the cleaning solution coating unit 162 in the lower direction of the inclination is limited to a position at which the coating layer 161 of the cleaning solution is in contact with the whole face of the nozzle surface 72A. In a case where the coating layer 161 of the cleaning solution is not in contact with the nozzle surface 72A, wiping may be performed in a state where the cleaning solution does not adhere thereto when performing wiping using the wiping unit 274, and there is a possibility of damaging the nozzle surface 72A. Accordingly, the cleaning solution coating unit 162 is preferably moved in a range between a position at which the coating layer 161 of the cleaning solution is in contact with the whole face of the wing cover 72D disposed on the upper side in the inclining direction of the ejection face 272 and a position at which the coating layer 161 is not in contact therewith. By adjusting the contact area between the wing cover 72D and the coating layer 161 of the cleaning solution, the adhering amount of the cleaning solution can be adjusted.

As the moving means 168 of the cleaning solution coating unit, the movement may be made by using a rail, or, similarly to the device that moves the above-described head to the maintenance unit, or the movement may be made by using a ball screw, a guide shaft, and a guide rail member, and the moving means is not particularly limited. In addition, in FIGS. 7 and 8, although the moving means 168 is disposed in the cleaning solution coating unit 162, by disposing the moving means in the head 72, the overlapping between the ejection face 272 and the cleaning solution maintaining face 162A can be controlled. In addition, it may be configured such that the moving means are disposed in both the cleaning solution coating unit 162 and the head 72 and are relatively moved from each other.

In addition, the adjustment of the amount of applied cleaning solution is not limited to be performed by changing the overlapping between the ejection face 272 and the cleaning solution maintaining face 162A, and, by relatively moving the cleaning solution supplying port 163 with respect to the ejection face 272, the amount of the cleaning solution applied to the ejection face 272 can be adjusted. In addition, it may be configured such that a plurality of the cleaning solution supplying ports 163 is disposed in the cleaning solution maintaining face 162A, and the adjustment is made by selecting a cleaning solution supplying port 163 such that the amount of the applied cleaning solution is optimal.

The adhering amount of the cleaning solution is adjusted based on an unused time of the nozzle, the coverage of an image (printing pattern), and the number of prints. The unused time described here, for example, represents a set time from after the use of the nozzle is has been completed until the nozzle is started to be used again, and more particularly, represents a standby time after use, a time until printing is resumed after maintenance, or the like.

The maintenance condition (the moisture state of the web) when performing wiping can be determined by the adhering amount of the cleaning solution. The maintenance performance (the state of ink drawn from the nozzle surface, a time required for stabilizing the printing quality after maintenance, and the like) greatly changes in accordance with the moisture state of the web. For example, in low-moisture maintenance in which the adhering amount of the cleaning solution is small, although a wipe mark remains on the nozzle surface, the printing quality is stable, and accordingly, the low-moisture maintenance can be used for a maintenance operation during printing. On the other hand, in high-moisture maintenance in which the adhering amount of the cleaning solution is large, although the nozzle surface can be maintained to be extremely clean, it takes time to stabilize the printing quality. Accordingly, it is preferable to adjust the adhering amount of the cleaning solution in accordance with the state of uncleanness of the nozzle surface, the operation history, and the time until the restart of printing after maintenance. Regarding the state of uncleanness of the nozzle surface, the adhering amount of the cleaning solution can be adjusted by checking the state using a camera or visual observation. In a case where the number of prints is large, and coating with many liquid droplets is performed based on the printing pattern, the nozzle surface is considered to be unclean, and it is preferable that wiping is performed by causing a large amount of the cleaning solution to adhere.

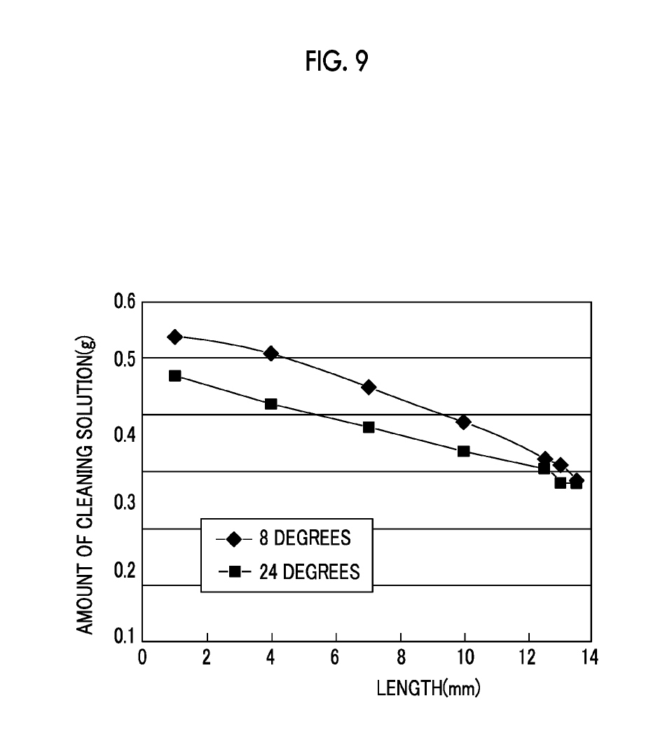

FIG. 9 is a graph that illustrates the relation between the adhering amount of the cleaning solution and a distance between the end portion of the ejection face 272 and the cleaning solution supplying port 163. The data illustrated in FIG. 9 represents cases where the angle of inclination of the ejection face 272 with respect to the horizontal plane is set to 8 degrees and 24 degrees. It can be checked that the adhering amount of the cleaning solution decreases by lengthening the distance from the end portion of the ejection face 272 to the cleaning solution supplying port 163. In the case illustrated in FIG. 9, a measurement is made in the condition that the viscosity of the cleaning solution is 2.3 cp, the contact angle of the nozzle surface is 90 degrees, and the contact angle of the wing cover 72D is 80 degrees. In addition, in the head and the cleaning solution coating unit 162, which are used for the measurement, the coating layer 161 of the cleaning solution is not brought into contact with the nozzle surface 72A in a state where the distance L from the end portion of the ejection face 272 to the cleaning solution supplying port 163 exceeds 13 mm.

According to this embodiment, by changing the adhering amount of the cleaning solution, the moisture of the nozzle surface when performing wiping can be adjusted without changing the wiping conditions, whereby the quality of the cleaning can be improved.

As a wiping member that performs wiping, a web can be preferably used, and as the wiping conditions at that time, the compressing pressure of the web is 20 kPa, and the web transmission speed is set to 20 mm/sec. In addition, wiping can be performed by using a blade.

In addition, in the above-described embodiment, although the nozzle surface of the ejection head has been described to have a shape of being inclined with respect to the horizontal direction, the present invention is not limited thereto, and the ejection face of the ejection head may not be inclined. In such as case, it is preferable that the cleaning solution supplying port 163 is arranged so as to maintain the cleaning solution on the whole surface of the cleaning solution maintaining face 162A, and the number of cleaning solution supplying ports 163 is not limited. The other configurations may be similar to those of a case where the nozzle surface is inclined.

Control System

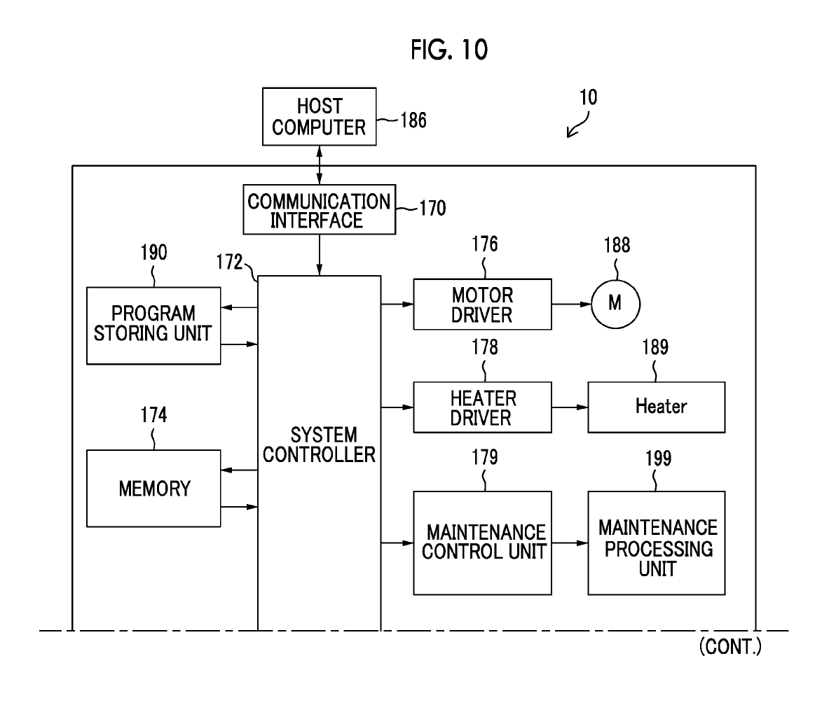

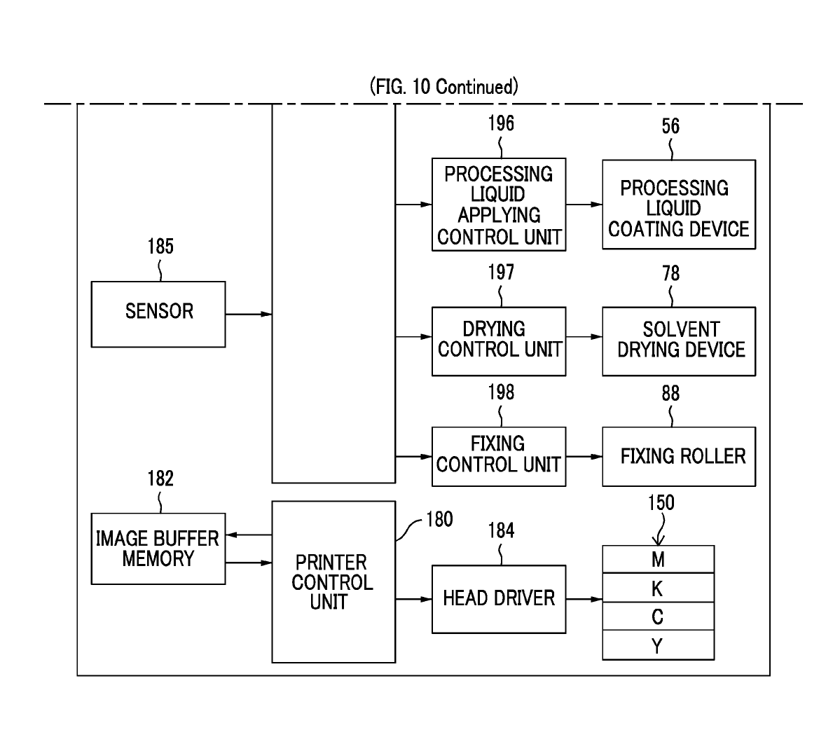

FIG. 10 is a block diagram of a main portion that illustrates the system configuration of the ink jet recording apparatus 10. The ink jet recording apparatus 10 includes a communication interface 170, a system controller 172, a memory 174, a motor driver 176, a heater driver 178, a print control unit 180, an image buffer memory 182, a head driver 184, and the like.

The communication interface 170 is an interface unit that receives image data that is transmitted from a host computer 186. As the communication interface 170, a serial interface such as a USB (Universal Serial Bus), IEEE1394, Ethernet (registered trademark), or a wireless network or a parallel interface such as Centronics can be used. In this part, a buffer memory (not shown) that is used for increasing the communication speed may be mounted. The image data transmitted from the host computer 186 is received by the ink jet recording apparatus 10 through the communication interface 170 and is temporarily stored in the memory 174.

The memory 174 is storing means for temporarily storing an image input through the communication interface 170, and data reading/writing is performed through the system controller 172. The memory 174 is not limited to a memory that is formed from a semiconductor element, and a magnetic medium such as a hard disk may be used.

The system controller 172 is configured by a central processing unit (CPU), peripheral circuits thereof, and serves as a control device that controls the overall operation of the ink jet recording apparatus 10 in accordance with a predetermined program and serves as a calculation device that performs various calculations. In other words, the system controller 172 performs communication control for communication with the host computer 186, control of reading data into or writing data into the memory 174, and the like by controlling units such as the communication interface 170, the memory 174, the motor driver 176, the heater driver 178, a processing liquid applying control unit 196, a drying control unit 197, a fixing control unit 198 and the like and generates control signals used for controlling each of the above-described units.

In the memory 174, programs executed by the CPU of the system controller 172 and various kinds of data required for the control process are stored. The memory 174 may be storing means in which data cannot be overwritten or storing means such as an EEPROM in which data can be overwritten. The memory 174 is used as a temporarily area of the image data and is also used as a program expanding area and a calculation work area of the CPU.

In the program storing unit 190, various control programs are stored, and the control program is read out and executed in accordance with an instruction transmitted from the system controller 172. As the program storing unit 190, a semiconductor memory such as a ROM or an EEPROM may be used, or a magnetic disk or the like may be used. In addition, a memory card including an external interface or a PC card may be used. It is apparent that a plurality of recording media out of such recording media may be included. Furthermore, the program storing unit 190 may serve also as a recording means (not shown) of operation parameters or the like.

The motor driver 176 is a driver that drives the motor 188 in accordance with an instruction transmitted from the system controller 172. In FIG. 10, it is denoted by reference numeral 188 for representing a motor that is arranged in each unit inside the apparatus. For example, in the motor 188 illustrated in FIG. 10, a motor that drives the rotation of the sheet feeding cylinder 52, the processing liquid drum 54, the drawing drum 70, the drying drum 76, the fixing drum 84, the delivery cylinder 94, and the like illustrated in FIG. 1, a motor that drives the rotation of intermediate conveying bodies 32 of the first to third intermediate conveying units 26, 28, and 30, and the like are included.

The heater driver 178 is a driver that drives the heater 189 in accordance with an instruction that is transmitted from the system controller 172. In FIG. 10, it is denoted by reference numeral 189 for representing a heater that is arranged in each unit inside the apparatus. For example, in the heater 189 illustrated in FIG. 10, the halogen heater 86 of the solvent drying device 78 that is disposed in the drying unit 18 illustrated in FIG. 1 and the like are included. In addition, heaters that heats the surfaces of the drying drum 76 and the fixing drum 84 illustrated in FIG. 1 are also included.

Furthermore, this ink jet recording apparatus 10 includes the processing liquid applying control unit 196, the drying control unit 197, and the fixing control unit 198 and controls the operation of units such as the processing liquid coating device 56, the solvent drying device 78, and the fixing roller 88 in accordance with an instruction transmitted from the system controller 172.

The print control unit 180 has a signal processing function for performing various processes, correction, and the like for generating a printing control signal based on the image data stored in the memory 174 under the control of the system controller 172 and is a control unit that supplies generated printing data (dot data) to the head driver 184. A necessary signal process is performed by the print control unit 180, and the ejected liquid droplet amount (amount of ejection) or the ejection timing of the head 72 are controlled based on the image data through the head driver 184. Accordingly, a desired dot size and a desired dot arrangement are realized.

In addition, the print control unit 180 may include an image buffer memory 182, and data such as the image data or parameters is temporarily stored in the image buffer memory 182 when the print control unit 180 processes the image data. In addition, a form may be employed in which the print control unit 180 and the system controller 172 are integrated into one processor.

The head driver 184 is configured so as to include a driving circuit that generates a driving signal applied to a piezoelectric element 158 of the head 72 based on the image data that is supplied from the print control unit 180 and drives the piezoelectric element 158 by applying the driving signal to the piezoelectric element 158. In addition, in the head driver 184 that is illustrated in FIG. 9, a feedback control system that is used for maintaining the driving condition of the head 72 to be constant may be included.

The sensor 185 includes various sensors that are disposed in each unit inside the apparatus and includes a temperature sensor, a position detecting sensor, a pressure sensor, and the like, in addition to the in-line sensor 90 that is illustrated in FIG. 1. The output signal of the sensor 185 is sent to the system controller 172, and the system controller 172 controls each unit of the apparatus by transmitting a control signal to each unit based on the output signal.

The maintenance control unit 179 (movement amount control unit) is a processing block that controls the maintenance processing unit 199 (see FIG. 5) that includes the cleaning processing unit 160 illustrated in FIGS. 6 to 8 based on a control signal that is transmitted from the system controller 172.

Although a detailed configuration of the maintenance control unit 179 is not shown, the maintenance control unit 179, based on the control signal transmitted from the system controller 172, controls the movement timing and the movement speed of the head 72 in the processing area of the cleaning processing unit 160 and controls the opening/closing of the valve 166, conveying driving of the web of the wiping unit 274, and the operation of a vertical mechanism of the web and the like.

In other words, the maintenance control unit 179 controls the maintenance processing unit 199 such that maintenance of the head 72 (i.e., the process of cleaning the nozzle surface 72A) is performed in the following order.

First, the maintenance control unit 179 moves the head 72 to the processing area of the maintenance processing unit 199. Next, the maintenance control unit 179 adjusts the adhering amount of the cleaning solution to the ejection face 272 by moving the cleaning solution coating unit 162 in parallel with the sub-scanning direction of the ejection face 272 using the moving means 168. A method of adjusting the adhering amount of the cleaning solution, as described above, can be performed by adjusting the overlapping between the ejection face 272 and the cleaning solution maintaining face 162A. In addition, the maintenance control unit 179 adjusts the clearance between the cleaning solution maintaining face 162A (see FIG. 7) and the nozzle surface 72A by vertically moving the cleaning solution coating unit 162 using the moving means 168.

When the positions of the head 72 and the cleaning solution coating unit 162 are determined, the cleaning solution is supplied from the cleaning solution supplying port 163 to the cleaning solution maintaining face 162A. The amount of the cleaning solution supplied from the cleaning solution supplying port 163 to the cleaning solution maintaining face 162A per unit time can be determined based on the size and the shape of the used cleaning solution supplying port 163, and the supply of the cleaning solution can be performed in accordance with a head pressure difference by opening or closing the valve 166.

After the coating layer 161 of the cleaning solution between the ejection face 272 and the cleaning solution maintaining face 162A broadly spreads on the whole, the maintenance control unit 179 moves the head 72 in the longitudinal direction while maintaining the clearance between the ejection face 272 and the cleaning solution maintaining face 162A by rotating the ball screw 284 using driving means not shown and coats the ejection face 272 with the cleaning solution. During the movement of the head 72, the cleaning solution is supplemented from the cleaning solution supplying port 163 such that the coating layer 161 of the cleaning solution be kept between the ejection face 272 and the cleaning solution maintaining face 162A.

After a predetermined time elapses after the ejection face 272 is coated with the cleaning solution, the head 72 is moved to the processing area of the wiping unit 274, and the cleaning solution of the nozzle surface 72A is cleaned out by the wiping unit 274. In addition, the head 72 is moved to the processing area of the nozzle cap 276, and preliminary ejection of the head 72 is performed. After the maintenance process of the head 72 is completed, the head 72 is moved to a predetermined drawing position.

According to the cleaning processing unit 160 configured as described above, when the cleaning solution is supplied between the cleaning solution maintaining face 162A and the ejection face 272 that are arranged so as to be parallel to and approximately parallel to the ejection face 272, the cleaning solution broadly spreads between the ejection face 272 and the cleaning solution maintaining face 162A, and accordingly, the ejection face 272 can be coated with the cleaning solution in a non-contacting manner. Particularly, in a case where the nozzle surface is inclined with respect to the horizontal plane, the cleaning solution can be moved from the upper portion to the lower portion of the inclination, and whereby the cleaning solution can broadly spread. In addition, by moving the cleaning solution coating unit 162 in parallel with the ejection face 272 in a direction perpendicular to the movement direction of the head 72 when performing maintenance, an area in which the ejection face 272 and the cleaning solution maintaining face 162A face with each other is decreased, whereby the adhering amount of the cleaning solution can be decreased. Therefore, the wiping can be performed in an optimal moisture state, and accordingly, the cleaning performance can be improved.

What is claimed is:

1. A nozzle surface cleaning device comprising:
an ink jet head having a nozzle surface in which a nozzle for ejecting a liquid is disposed;
a cleaning solution supplying unit that faces the nozzle surface and supplies a cleaning solution;
a movement unit that moves at least one of the cleaning solution supplying unit and the ink jet head in a longitudinal direction and a traverse direction of the ink jet head; and
a movement amount control unit that controls a movement amount moving by the movement unit of at least one of the cleaning solution supplying unit and the ink jet head,
wherein the movement amount control unit adjusts an amount of the cleaning solution adhering to the nozzle surface by moving at least one of the cleaning solution supplying unit and the ink jet head in the traverse direction of the ink jet head by using the movement unit in accordance with one of an uncleanness state of the nozzle surface and an operation history of the ink jet head so as to relatively change a position at which the nozzle surface and the cleaning solution supplying unit face and overlap with each other.

2. The nozzle surface cleaning device according to claim 1,
wherein the cleaning solution supplying unit comprises:
a cleaning solution maintaining face that is separated from the nozzle surface by a predetermined distance and is disposed in parallel with the nozzle surface; and
a cleaning solution supplying port that supplies the cleaning solution to the cleaning solution maintaining face.

3. The nozzle surface cleaning device according to claim 2, wherein the cleaning solution supplying unit fills the cleaning solution between the nozzle surface and the cleaning solution maintaining face.

4. The nozzle surface cleaning device according to claim 1, wherein the nozzle surface is inclined with respect to a horizontal plane.

5. The nozzle surface cleaning device according to claim 2, wherein the nozzle surface is inclined with respect to a horizontal plane.

6. The nozzle surface cleaning device according to claim 3, wherein the nozzle surface is inclined with respect to a horizontal plane.

7. The nozzle surface cleaning device according to claim 1, further comprising a supporting member that is adjacent to the nozzle surface and supports the nozzle surface,
wherein the movement amount control unit adjusts the adhering amount of the cleaning solution to the supporting member.

8. The nozzle surface cleaning device according to claim 2, wherein the cleaning solution supplying port is disposed on a cleaning solution maintaining face side that faces the nozzle surface.

9. The nozzle surface cleaning device according to claim 1, wherein the movement amount control unit increases the adhering amount of the cleaning solution by adjusting the movement amount as an unused time of the nozzle increases.

10. The nozzle surface cleaning device according to claim 1, wherein the movement amount control unit changes the adhering amount of the cleaning solution by adjusting the movement amount in accordance with a printing pattern of a formed image.

11. The nozzle surface cleaning device according to claim 1, wherein the movement amount control unit increases the adhering amount of the cleaning solution by adjusting the movement amount as a number of prints increases.

12. A liquid droplet ejecting apparatus comprising:
the nozzle surface cleaning device according to claim 1.
